(19) United States
(12) Patent Application Publication
(10) Pub. No.: US 2006/0109642 A1
(43) Pub. Date: May 25, 2006

(54) Colorful luminescent keyboard

(75) Inventor: Ching-Hsiang Chang, Taipei (TW)

Correspondence Address: G. LINK CO., LTD;Suite 137, PMB 174, 931 West, 75th Street, Naperville, IL, 60565, US

(73) Assignee: BEHAVIOR COMPUTER TECH CORP.

(21) Appl. No.: 10/993,843

(22) Filed: Nov. 22, 2004

(51) Int. Cl. F21V 33/00

(52) U.S. Cl. 362/85; 362/231; 362/109

(57) ABSTRACT

The present invention is disclosed a colorful luminescent keyboard comprising of a plurality of key switches, a colorful luminescent board used for the plurality of key switches to provide different luminescent colors of which the colorful luminescent board at least includes plurality of luminescent areas and each luminescent area emits respective colorful light and respectively corresponding key switches.

### FIELD OF THE INVENTION

The present invention is related to a keyboard, especially to a colorful luminescent keyboard.

### BACKGROUND OF THE INVENTION

The conventional luminescent keyboard by using the luminescent board as a light source is mainly to provide the keyboard with a continuous usage in a dark environment. The structure of the conventional luminescent keyboard is mainly to place the luminescent board inside the keyboard, and when the luminescent board is powered up, the luminescent board emits colorful lights by electricity and makes the keyboard show a colorful shining effect. However, the object of such a luminescent board for the luminescent keyboard is merely offered as a light source in a dark environment, the luminescent board emits only one color light as a result of the luminescent keyboard showing only one color. Consequently, the method to investigate key switches on the keyboard by the user is dependent on the illumination of key switches, it results in more power consumption.

The inventor of the present invention investigates the drawbacks of the above conventional luminescent keyboard to improve and invent a colorful luminescent keyboard which utilizes the colorful luminescent board to emit many colorful lights in order to offer the luminescent light source in a dark environment and, in advance, provide the convenience in investigating the key switches on the keyboard.

### SUMMARY OF THE INVENTION

The first object of the present invention is to provide a luminescent keyboard with many different luminescent lights simultaneously.

The second object of the present invention is to provide a luminescent keyboard which is kept in continuous usage in a dark environment and also increases the correctness of pushing the right key switches to avoid wrong strikes of the key switches.

To achieve the above purpose, the present invention provides a colorful luminescent keyboard comprising of a plurality of key switches, a colorful luminescent board used for the plurality of key switches to provide different luminescent colors of which the colorful luminescent board at least includes plurality of luminescent areas and each luminescent area emits respective colorful light and respectively corresponding key switches.

### BRIEF DESCRIPTION OF THE DRAWINGS

The above objects and advantages of the present invention will become more apparent with reference to the appended drawings wherein:

FIG. 1 shows the structurally decomposed drawings of the present invention of colorful luminescent keyboard;

FIG. 2 shows one example of plurality of luminescent areas of colorful luminescent board corresponding to the arrangement of the plurality of key switches of the keyboard; and

FIG. 3 shows another example of plurality of luminescent areas of colorful luminescent board corresponding to the arrangement of the plurality of key switches of the keyboard.

### DETAILED DESCRIPTION OF THE INVENTION

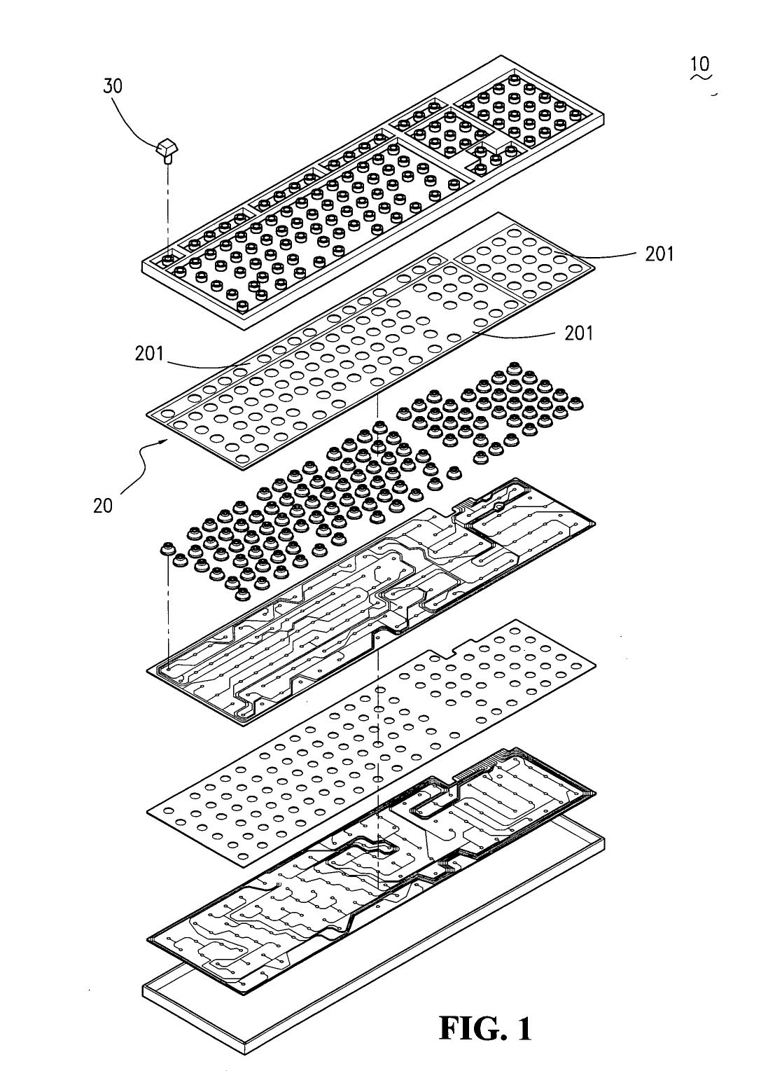

FIG. 1 shows the structurally decomposed drawings of the present invention of colorful luminescent keyboard. The colorful luminescent keyboard 10 of the present invention is assembled by at least a plurality of key switches 20 and a colorful luminescent board 20. The present invention completely utilizes the electroluminescent property of the luminescent board to the keyboard in order to make the key switches of colorful luminescent keyboard 10 show different colors. The present invention mainly uses a colorful luminescent board 20 with plurality of luminescent areas 201, each luminescent area 201 electroluminescently irradiates respective color, for instance, a colorful luminescent board 20 with three different luminescent areas 201 which respectively electroluminescently irradiates blue, green and yellow colors. The present invention equips colorful luminescent board 20 inside the keyboard 10, for instance, equipping colorful luminescent board 20 beneath the key caps of key switches 30 to match key switches 30 of the present invention in using transparent key switches in order to make the emission lights from colorful luminescent board 20 pass through.

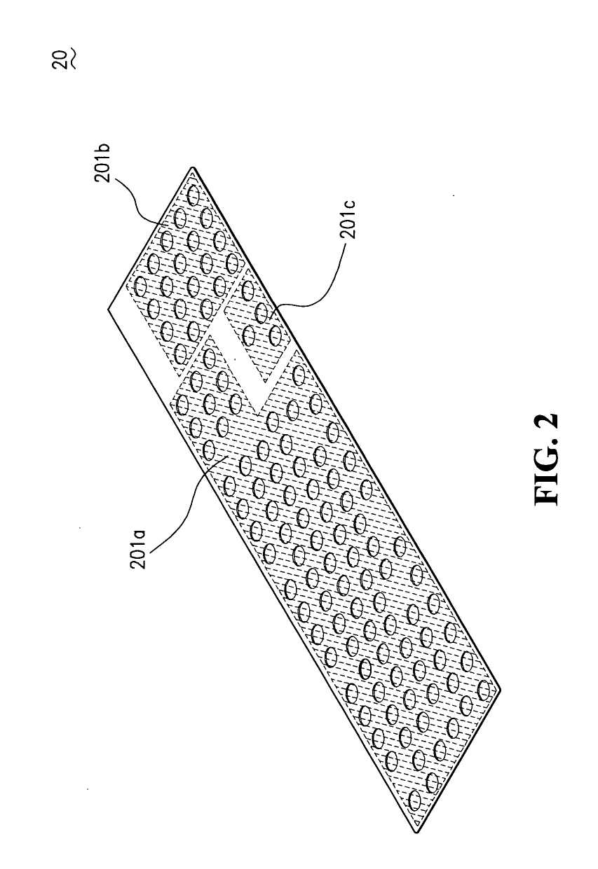

FIG. 2 demonstrates one example of plurality of luminescent areas of colorful luminescent board corresponding to the arrangement of the plurality of key switches of the keyboard. The luminescent area 201a of FIG. 2 is an area to cover most of the keyboard to make colorful luminescent keyboard 10 of the present invention emit a preset color light, for instance, using electroluminescent blue light as the color light of luminescent area 201a as to make colorful luminescent keyboard 10 be a luminescent keyboard with shining blue light. Meanwhile, luminescent area 201b is an area covering plurality of numeric key switches and adjacent key switches, for instance, an area locating at the right side of the standard keyboard with 0 to 9 numbers of key switches and adjacent key switches. The colors of luminescent area 201b is different from luminescent area 201a so as to make colorful luminescent keyboard 10 of the present invention show different color effect on those of numeric key switches and adjacent key switches. Again, luminescent area 201c is an area covering plurality of specially designated key switches, for instance, arrow-up key button, arrow-down key button, arrow-left key button and arrow-right key button. The color used for luminescent area 201c is different from luminescent areas 201a and 201b.

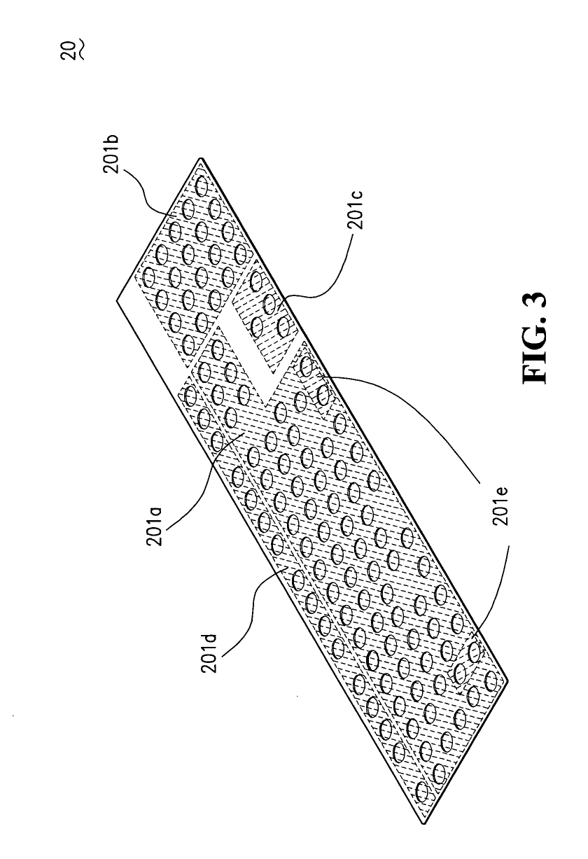

FIG. 3 demonstrates another example of plurality of luminescent areas of colorful luminescent board corresponding to the arrangement of the plurality of key switches of the keyboard. Luminescent area 201d of FIG. 3 is an area covering plurality of functional key switches which are generally called hot keys. Similarly, luminescent area 201d uses different colors from others. Furthermore, luminescent area 201e is an area of plurality of key switches used for being capable of matching specific software, for instance, game softwares and business application softwares. Using one practical embodiment to interpret luminescent area 201e, for instance, a game software using “A”, “Z”, ”.” and “/” as four input key switches, luminescent area 201e corresponds these four key switches and makes these four key switches show different colors from other areas.

Colorful luminescent keyboard 10 of the present invention utilizes electroluminescent property to make the keyboard keep a continuous usage in a dark environment and in advance to significantly increase the correctness of pushing right key switches and effectively reduce wrong strikes of key switches.

Those who are familiar with the technology should understand that they could do other modifications within the spirit and scope of the present invention. And the coverage of the present invention includes any modification and change within the claims and the corresponding point of view.

What is claimed is:

1. A colorful luminescent keyboard, comprising:
a plurality of key switches;
a colorful luminescent board, which is used to offer the plurality of key switches with plurality of colors, wherein the colorful luminescent board includes at least plurality of luminescent areas and each luminescent area emits respectively different color light and respectively corresponds to the key switches.

2. The colorful luminescent keyboard as define in claim 1, wherein one of the luminescent area corresponds to plurality of functional key switches.

3. The colorful luminescent keyboard as defined in claim 1, wherein one of the luminescent area corresponds to plurality of numeric key switches.

4. The colorful luminescent keyboard as defined in claim 1, wherein one of the luminescent area corresponds to plurality of key switches used for matching specific softwares.

5. The colorful luminescent keyboard as defined in claim 1, wherein one of the luminescent area corresponds to plurality of specific designated key switches.

6. The colorful luminescent keyboard as defined in claim 1, wherein the colorful luminescent board emits at least two color lights.

7. The colorful luminescent keyboard as defined in claim 1, wherein the key switches are transparent key switches.

8. The colorful luminescent keyboard as defined in claim 1, wherein the colorful luminescent board is placed inside the colorful luminescent keyboard.

9. The colorful luminescent keyboard as defined in claim 1, wherein the colorful luminescent board is placed beneath the belonged key caps of the plurality of key switches.

10. The colorful luminescent keyboard, comprising:
a plurality of key switches;
a colorful luminescent board, which is used to offer the plurality of key switches with plurality of colors, wherein the colorful luminescent board includes at least plurality of luminescent areas and each luminescent area emits respectively different color light and respectively corresponds to these key switches, these luminescent areas are used to investigate the key switches in a dark environment and increase the correctness of pushing right key switches and reduce wrong strikes of key switches.

11. The colorful luminescent keyboard as define in claim 10, wherein one of the luminescent area corresponds to plurality of functional key switches.

12. The colorful luminescent keyboard as defined in claim 10, wherein one of the luminescent area corresponds to plurality of numeric key switches.

13. The colorful luminescent keyboard as defined in claim 10, wherein one of the luminescent area corresponds to plurality of key switches used for matching specific softwares.

14. The colorful luminescent keyboard as defined in claim 10, wherein one of the luminescent area corresponds to plurality of specific designated key switches.

15. The colorful luminescent keyboard as defined in claim 10, wherein the colorful luminescent board emits at least two color lights.

16. The colorful luminescent keyboard as defined in claim 10, wherein the key switches are transparent key switches.

17. The colorful luminescent keyboard as defined in claim 10, wherein the colorful luminescent board is placed inside the colorful luminescent keyboard.

18. The colorful luminescent keyboard as defined in claim 10, wherein the colorful luminescent board is placed beneath the belonged key caps of the plurality of key switches.
